(19) United States
(12) Patent Application Publication
(10) Pub. No.: US 2005/0010704 A1
(43) Pub. Date: Jan. 13, 2005

(54) Serial hard disk drive selector

(76) Inventor: Michael J. Malone, Bensalem, PA (US)

Correspondence Address: Michael J. Malone, 1907 Juniper Lane, Bensalem, PA, 19020, US

(21) Appl. No.: 10/614,161

(22) Filed: Jul. 8, 2003

(51) Int. Cl. G06F 13/10

(52) U.S. Cl. 710/74

(57) ABSTRACT

For any specific, serial hard disk drive that occupies a specific logical position within a personal computer system, A Serial Hard Disk Drive Selector is disclosed that permits the replacement of one physically distinct, permanently mounted serial hard disk drive for another physically distinct, permanently mounted serial hard disk drive within the specific logical position occupied. This Serial Hard Disk Drive Selector simultaneously controls the address/command/data from host to drive connections, the address/command/data from drive to host connections, the ground connections, and the power supply connections of all hard disk drives connected to the Selector. This Serial Hard Disk Drive Selector operates by closing the address, command and control, and data to and from connections, and the power supply connections of the selected serial hard disk drive while opening these connections to all not-selected serial hard disk drives connected to the Serial Hard Disk Drive Selector. The choice of hard disk drive is made prior to booting the computer system and the choice is maintained until the computer system is turned off.

### BACKGROUND OF THE INVENTION

1. Field of the Invention

The present invention relates generally to a Serial Hard Disk Drive Selector mechanism that permits the easy and rapid replacement of one serial hard disk drive that occupies a unique, logical position in a computer system with another serial hard disk drive. The replacement occurs while the computer system is off. The replacement occurs without the removal of either serial hard disk drive.

2. Description of the Related Art

All components of a personal computer system are connected to each other and communicate with each other over a series of electrical conductors. Over other electrical conductors, electrical power is delivered to the components of the computer system. These conductors are typically wires or they are wire traces that are part of the electrical circuit boards that are used to construct computers. Together, these conductors are termed the computer system's bus. The complete computer system has a many-branched bus. The most peripheral segments are referred to as peripheral buses. In this application I will refer to these connections generically as either a trace or as traces.

The modern computer system has an architecture that relieves the central processing unit of much of the work of directly controlling the other components of the system. This is accomplished by placing host adapters within the bus of the computer system between the central processing unit and other computer system devices. These host adapters recognize instructions directed at their attached devices and cause their attached devices to perform as directed. Today's computer components are typically smart devices; they can often relieve the central processing unit of tasks by directly communicating with and accomplishing tasks with other computer components without utilizing the central processing unit directly. The various host adapters mediate these functions.

The host adapters of interest to this inventor are those that control hard disk drives. The bus segments of interest to this inventor are those connecting these host adapters to the computer system, those connecting the hard disk drives to the host adapter, and those delivering power to the hard disk drives. The peripheral devices of interest to this inventor are those hard disk drives, which are permanently mounted within a personal computer system.

Attached FIGS. 1 to and including 11 depict various relationships for these three component parts of a computer. Depictions are included for ATA (Advanced Technology Attachment) circuitry; for SCSI (Small Computer System) circuitry; for USB (Uniform Serial Bus) circuitry; for IEEE 1394 (Institute of Electrical and Electronics Engineers) circuitry; and, for S-ATA (Serial Advanced Technology Attachment) circuitry. ATA, SCSI, USB, IEEE 1394, and S-ATA are communication protocols. Attached FIGS. 4 to and including 11 depict these three component parts relationships when the Serial Hard Disk Drive Selector is part of the system.

Host adapters are labeled as 300, and each Figure has an additional entitling for its host adapter that identifies it as either an ATA, SCSI, USB, IEEE 1394, or S-ATA host adapter.

Hard disk drives, in like manner, are labeled 400 with an additional entitling that identifies it as an ATA, SCSI, etc., hard disk drive, etc. Hard disk drive is abbreviated to HDD.

The bus of a typical personal computer system has six component parts. The first part is the traces that deliver power to components attached to the bus. This component is labeled 200A in all figures and entitled power delivery traces of bus system. The second part is the traces that deliver command signals. This component is labeled 200B in all figures and entitled command delivery traces of bus system. The third part is the traces that carry address signals. This is labeled 200C in all figures and entitled address delivery traces of the bus system. The fourth is the traces that deliver data. This is labeled 200D in all figures and is entitled data delivery traces of the bus system. The fifth part is the traces that delivery timing signals. This is labeled 200E in all figures and entitled timing delivery traces of the bus system. When traces 200B, C and D are combined, the Figures show this as 200F. The sixth part is the traces or wires that deliver power directly to the computer's components. These traces come directly from the computer system's power supply to a component. This part is labeled 100 in all figures and is entitled dc power.

The bulk of communications passed over the bus of a personal computer system is sent as parallel signals or as coordinated signals sent down many differing traces simultaneously; many being eight, or sixteen; or thirty two, or sixty four. Advances in electronics have recently led to the developed of much higher speed communication techniques using serial signals. Serial signals are coordinated signals sent down few traces; few being one or two. Part of this high-speed communication development is the introduction of serial hard disk drives for use in personal computer systems. These newly developed serial hard disk drives promise to replace, the now commonly used, parallel hard disk drives.

The commonly used parallel hard disk drives are the ATA and SCSI hard disk drives. At this time, three serial hard disk drives are readily available. They are the Serial ATA or S-ATA, IEEE 1394, and USB hard disk drives. IEEE 1394 and USB hard disk drives are typically external peripheral devices but internal computer component versions exist. Serial ATA or S-ATA is typically an internal peripheral component.

FIG. 1 depicts two different relationships; that of the ATA and SCSI devices. They are different devices, but their simplified schematics are the same. This figure shows that the bus components 200A, B, C, D, and E communicate with the ATA or SCSI parallel host adapter, 300, but that only components 200B, C, and D communicate with the ATA or SCSI parallel hard disk drive, 400. The parallel hard disk drives receive their power directly from the computer's power supply system via component 100, the dc power source.

FIG. 2 depicts two different relationships; that of the USB and the IEEE 1304 devices. IEEE is Institute of Electrical and Electronics Engineers; USB is Uniform Serial Bus. They are different devices but their simplified schematics are the same. This figure shows that the bus components 200A, B, C, D, and E communicate with the USB or IEEE 1394 serial host adapter, 300, but that bus components 200B, C, and D are combined and connect to either the USB or IEEE 1394 serial hard disk drive, 400, via bus component 200F. Power to these serial hard disk drives is from bus component 200A. Bus component 100, dc power supply, does not, typically, connect to the USB or IEEE 1394 serial hard disk drive.

FIG. 3 depicts the typical relationship between an S-ATA host adapter, 300, and its serial hard disk drive, 400. This figure shows that bus components 200A, B, C, D, and E communicate with the S-ATA host adapter but that components 200B, C and D are combined and communicate with the hard disk drive, 400, via a single component, 200F. Power is supplied to the S-ATA hard disk drive by bus component 100, directly from the system's power supply.

The most distinguishing architectural feature of the serial hard disk drives is the use of a peripheral bus component that serves multiple functions; specifically, the command, address, and data delivery. Component 200F is unique to the serial bus architecture. Command, address, and data delivery for the parallel hard disk drive bus is accomplished by separate components.

In U.S. Pat. No. 6,480,350 B1, dated Nov. 12, 2002, inventor Malone discloses the present state of the art with his patented hard disk drive selector. Malone's invention is a three component, multi-pole, multi-throw, switching device that resides permanently within a personal computer system. The hard disk drive selector permits the rapid and easy replacement of one permanently mounted physical parallel hard disk drive occupying a single logical position within a computer system with another permanently mounted parallel hard disk drive within the same computer system. Malone's Hard Disk Drive Selector is configurable and can be used to choose any one parallel hard disk drive for use from a plurality of available parallel hard disk drives permanently mounted within the computer system.

When Malone's invention is used, a particular setting is chosen while the computer system is off. When the computer system is turned on, booted, the selected parallel hard disk drive is used for that entire computer use session. If another parallel hard disk is to be used, the computer system is turned off. When the computer system is turned off, the other parallel hard disk drive is selected utilizing Malone's Hard Disk Drive Selector and the computer is booted with the newly selected parallel hard disk drive in use for this new computer use session.

Malone's invention, the Hard Disk Drive Selector resides between the parallel hard disk drive host adapter and its parallel hard disk drive and within the hard disk drive's peripheral bus system. The Hard Disk Drive Selector also resides between the system's power supply and parallel hard disk drive.

Malone's invention specifically aims at controlling the bus of a peripheral hard disk drive that has four distinct segments. The four segments are the power delivery bus components, the command delivery bus components, the address delivery bus components, and the data delivery bus components. When operated, Malone's invention opens the power, command, and address delivery components to any and all not-selected hard disk drives controlled by the invention and closes the power, command, and address components to the selected hard disk drive controlled by the invention. With this invention, the data delivery components of the peripheral hard disk drive bus are left closed to all hard disk drives controlled by the invention at all times; to both selected and not-selected hard disk drives controlled by the invention.

Malone's invention is specific to the control of and selection and not-selection of parallel type hard disk drives.

Malone's invention, The Hard Disk Drive Selector, offers unprecedented versatility and protection in the use and storage of parallel hard disk drives and in the protection of software and data stored on the drives, but it fails to work with serial hard disk drives and to extend this protection to serial hard disk drives.

Already developed devices are now discussed.

U.S. Pat. No. 6,480,350 B1, issued to Malone, discloses a device that permits the user selected use of one parallel hard disk drive from a plurality of parallel hard disk drives controlled by his invention.

U.S. Pat. No. 6,009,518 A, issued to Shiakallis, discloses a device and means of separating and storing data in differing locations during a single computer use session.

U.S. Pat. No. 6,272,533 B1, issued to Browne, discloses a device and means to prevent the writing of data to a hard disk drive while permitting reading of data from the hard disk drive.

U.S. Pat. No. 3,986,169, issued to Kobayashi et al., discloses a device that permits the transferring of data between two computer systems.

U.S. Pat. No. 4,176,341, issued to Miyazaki, discloses a device that permits time-sharing of a data path by multiple Input/Output devices.

U.S. Pat. No. 5,574,929, issued to Pieterse et al., discloses a device that permits a computer system to use two central processing units.

U.S. Pat. No. 5,630,171, issued to Chejlava, Jr., et al., discloses a device that translates Direct Memory Access mode data transfers into Input/Output mode data and other data modes.

U.S. Pat No. 5,761,460, issued to Santos et al., discloses a temporary dual-master storage device.

U.S. Pat. No. 5,724,554, issued to Gish, discloses a device and method that permits a 25 pin computer connecting cable to automatically switch from serial to parallel mode or to automatically switch from parallel to serial mode.

International Pat. No. 83305547.8, issued to Barber, discloses a device that allows dual port access to a target circuit after determining priority of need for use of the circuit determined by algorithm.

Malone discloses a device that controls parallel hard disk drives only. The other inventors sited all disclose inventions that are active mediators within the data path whether the data path is serial or parallel.

These references are cited after search of International Patent Classes G 06 F 13/00 and G 11 B 05/02 and U.S. Patent Classes 360/61, 63, 64, 69, 137 and 711/112.

### SUMMARY OF THE PRESENT INVENTION

This application for patent of an invention discloses a novel method and technique that permits the rapid and easy replacement of one, permanently mounted, serial hard disk drive by another permanently mounted, serial hard disk drive in a single, logical serial hard disk drive position in a personal computer system. The method and invention allows the exchange to be made without the physical removal and replacement of the serial hard disk drives and is accomplished by multi-pole, multi-throw switching devices. This method, additionally, provides software security that otherwise, could only be accomplished by the removal of the serial hard disk drive from the computer system.

### BRIEF DESCRIPTIONS OF THE DRAWINGS

There are fourteen drawings and charts. All are titled as Figure. All of the Figures are in related sets. For simplicity, each figure depicting the operation of this device will only show two devices attached to the invention. The invention is able to control two, three, four, etc., number of devices.

The first set is comprised of FIGS. 1, 2, and 3. Figures depict the typical relationship between parallel and serial hard disk drives.

FIG. 1 is specific to the ATA and SCSI environment. It shows the typical relationship between the computer system's bus and the computer system's host adapter; the host adapter and the hard disk drive; and the hard disk drive and the system's power supply.

FIG. 2 is specific to the USB or IEEE 1394 environment. It shows the typical relationship between the computer system's bus and the computer system's host adapter; the host adapter and the hard disk drive; and the hard disk drive and the system's power supply.

FIG. 3 is specific to the S-ATA environment. It shows the typical relationship between the computer system's bus and the computer system's host adapter; the host adapter and the hard disk drive; and the hard disk drive and the system's power supply.

The second set is comprised of FIGS. 4 and 5. FIGS. 4 and 5 depict the Serial Hard Disk Drive Selector as it is to be placed between the serial host adapter and the serial hard disks this invention controls the choice of. These figures are specific to the USB serial formats.

FIG. 4: Shows the Serial Hard Disk Drive Selector selecting the serial hard disk drive at depict the Serial Hard Disk Drive Selector 1 position and not-selecting the serial hard disk drive at depict the Serial Hard Disk Drive Selector 2 position.

FIG. 5: Shows depict the Serial Hard Disk Drive Selector selecting the serial hard disk drive at depict the Serial Hard Disk Drive Selector 2 position and not-selecting the serial hard disk drive at depict the Serial Hard Disk Drive Selector 1 position.

The third set is comprised of FIGS. 5 and 6. FIGS. 6 and 7 depict the Serial Hard Disk Drive Selector as it is to be placed between the serial host adapter and the serial hard disks the Serial Hard Disk Drive Selector controls the choice of. These figures are specific to the IEEE1394 serial formats.

FIG. 6: Shows the Serial Hard Disk Drive Selector selecting the serial hard disk drive at the Serial Hard Disk Drive Selector 1 position and not-selecting the serial hard disk drive at the Serial Hard Disk Drive Selector 2 position.

FIG. 7: Shows the Serial Hard Disk Drive Selector selecting the serial hard disk drive at the Serial Hard Disk Drive Selector 2 position and not-selecting the serial hard disk drive at the Serial Hard Disk Drive Selector 1 position.

The fourth set is comprised of FIGS. 8 and 9. FIGS. 8 and 9 depict the Serial Hard Disk Drive Selector as it is to be placed between the serial host adapter and the serial hard disks the Serial Hard Disk Drive Selector controls the choice of. These figures are specific to the Serial ATA format.

FIG. 8: Shows the Serial Hard Disk Drive Selector selecting the serial hard disk drive at the Serial Hard Disk Drive Selector 1 position and not-selecting the serial hard disk drive at the Serial Hard Disk Drive Selector 2 position.

FIG. 9: Shows the Serial Hard Disk Drive Selector selecting the serial hard disk drive at the Serial Hard Disk Drive Selector 2 position and not-selecting the serial hard disk drive at the Serial Hard Disk Drive Selector 1 position.

The fifth set is comprised of FIGS. 10 and 11. FIGS. 10 and 11 depict the component parts of the Serial Hard Disk Drive Selector and the relationship these component parts have to the host adapter and the general computer system bus.

FIG. 10: Shows the component parts of the Serial Hard Disk Drive Selector selecting the serial hard disk drive at the Serial Hard Disk Drive Selector 1 position and not-selecting the serial hard disk drive at the Serial Hard Disk Drive Selector 2 position.

FIG. 11: Shows the component parts of the Serial Hard Disk Drive Selector selecting the serial hard disk drive at the Serial Hard Disk Drive Selector 2 position and not-selecting the serial hard disk drive at the Serial Hard Disk Drive Selector 1 position.

The sixth set is composed of FIGS. 12, 13, and 14. Each of these figures is a table depicting the various connection pinnouts that are to be considered in configuring this invention.

FIG. 12: Shows the Uniform Serial Bus hard disk drive pinnout.

FIG. 13: Shows the IEEE 1394 hard disk drive pinnout.

FIG. 14: Shows the Serial ATA hard disk drive pinnout.

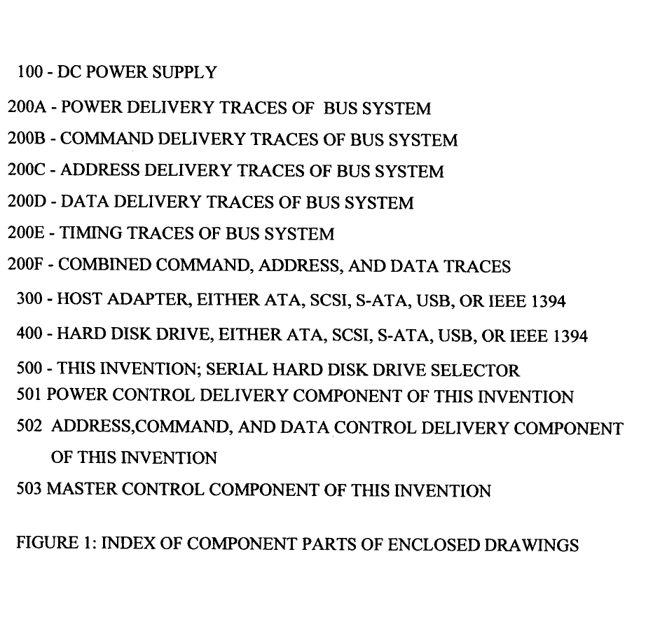

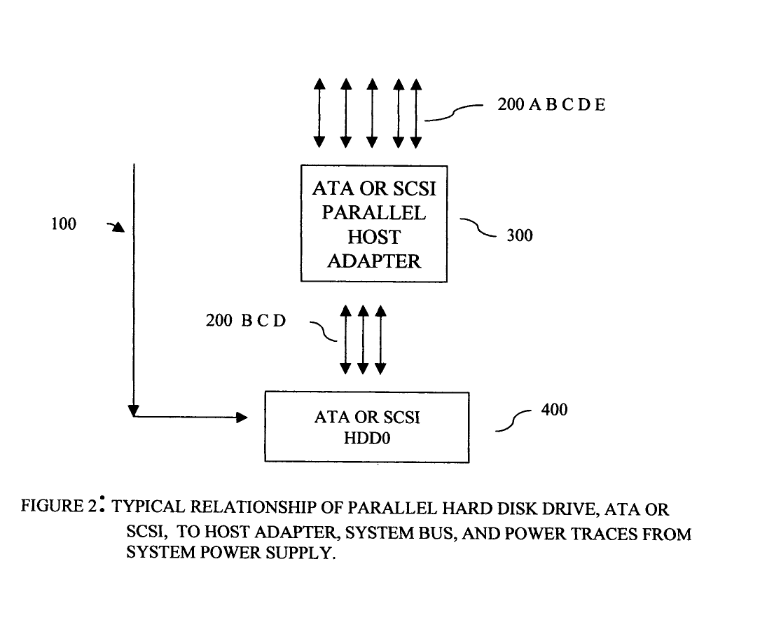

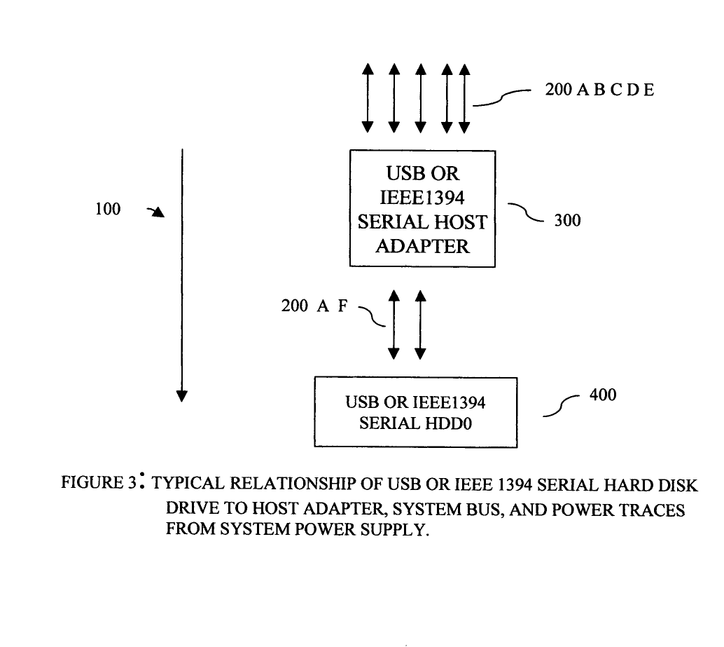

### DETAILED DESCRIPTION OF THE PREFERRED EMBODIMENT OF THE INVENTION

This Serial Hard Disk Drive Selector is a device that controls the selection of one physical, permanently mounted, serial hard disk drive to occupy a single logical hard disk drive position in a personal computer system. The choice is made from two, three, four, etc., physical, permanently mounted, serial hard disk drives attached to the invention.

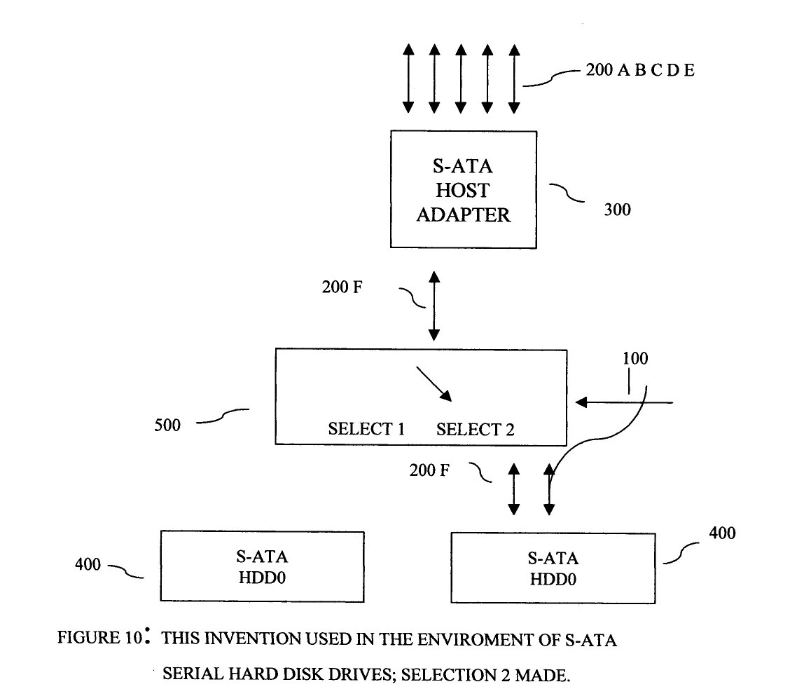

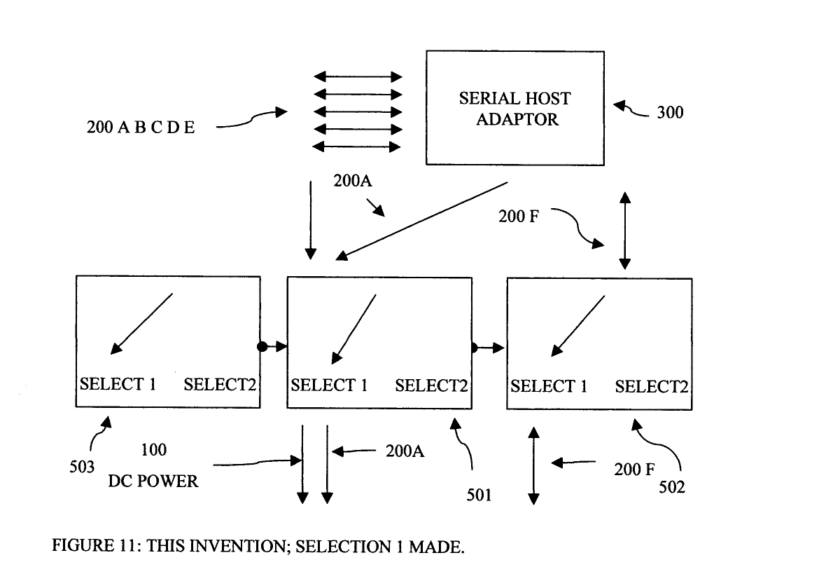

The Serial Hard Disk Drive Selector had three component parts. These parts are depicted in FIGS. 10 and 11 and are labeled as 501, 502, and 503. In all other Figures in which the Serial hard Disk Drive Selector is depicted, the three component parts are depicted as a single element and labeled as 500.

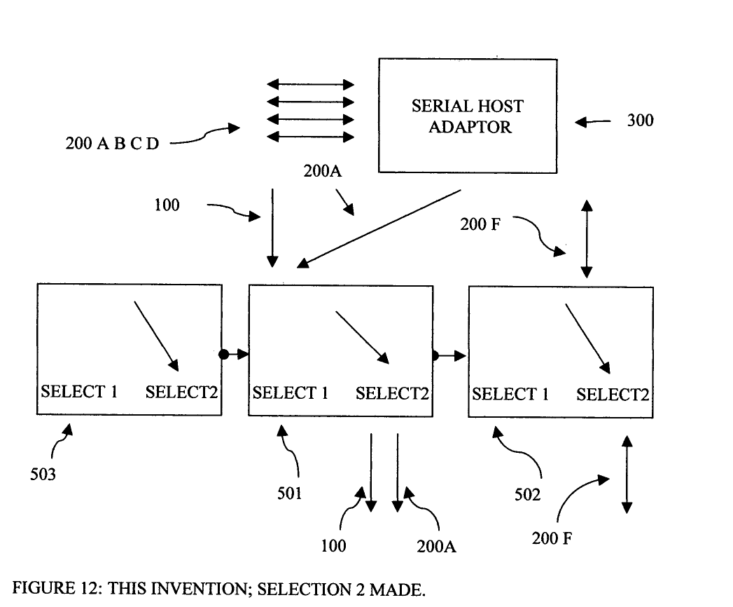

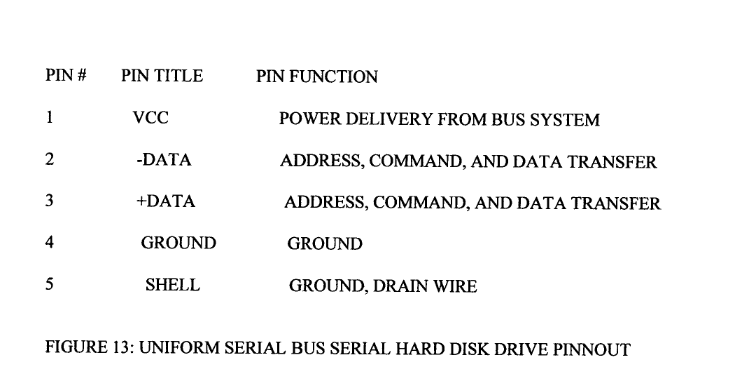

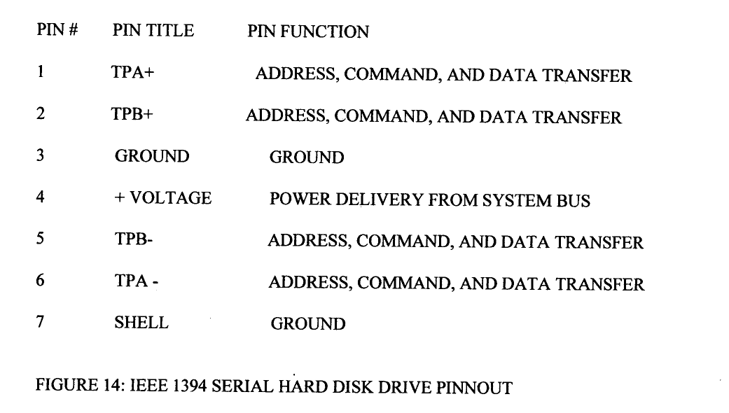

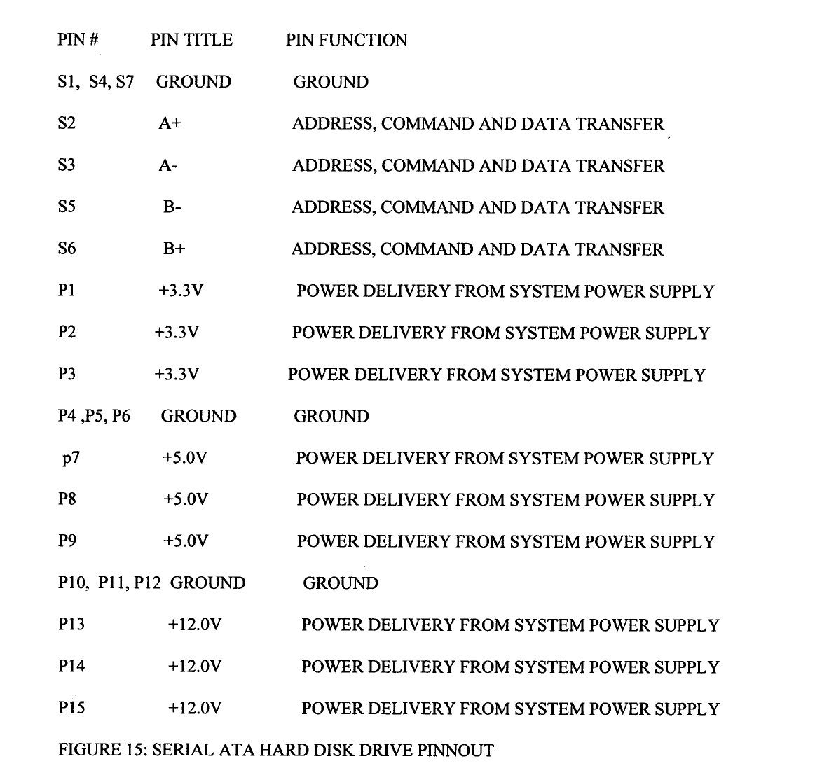

The first component part, 501, is the power control delivery component. It is a multi-pole, multi-throw switching device that controls the power traces for power delivered directly from the computer system's power supply via dc power supply, 100, and/or the computer system's power delivery traces of bus, 200A, to all serial hard disk drives permanently mounted in the computer system, attached to the Serial Hard Disk Drive Selector, 500, and selected for use by the Serial Hard Disk Drive Selector, 500. The power control delivery component closes all power delivery traces to a selected serial hard disk drive and opens all power delivery traces to all not-selected serial hard disk drives. The power delivery component, 501, is configurable. Being configurable means that it resides either in the dc power supply, 100, between the computer system power supply and the serial hard disk drive, 400, or between the serial host adapter, 300, and the serial hard disk drive, 400, within the power delivery traces of the bus, 200A, or both. Being configurable also means that the number of poles needed to effect this component differ from one serial format to another; these differing pole requirements are described in FIGS. 11, 12, and 13. Component 501 would require two (2) poles in the USB environment; two (2) poles in the IEEE 1394 environment; and, fifteen (15) poles in the S-ATA environment. Being configurable also means that this component may by constructed of mechanical, electromechanical, and/or electronic sub-components.

The second component part, 502, is the command, address, and data control delivery component. It is a multi-pole, multi-throw switching device that controls the combined command and address and data delivery traces, 200F, between all serial hard disk drives, 400, permanently mounted in the computer system and the serial host adapter, 300, that are connected to the Serial Hard Disk Drive Selector, 500. The command, address, and data control delivery component closes all combined command, address, and data delivery traces, 200F, to the selected serial hard disk drive and opens all combined command, address and delivery traces, 200F, to all not-selected serial hard disk drives. The command, address, data control delivery component, 502, is configurable. Being configurable also means that the number of poles needed to effect this component differ from one serial format to another; these differing pole requirements are described in FIGS. 11, 12, and 13. Component 502 would require three (3) poles in the USB environment; five (5) poles in the IEEE 1394 environment; and, seven (7) poles in the S-ATA environment. Being configurable also means that this component may by constructed of mechanical, electromechanical, and/or electronic sub-components.

The third component part, 503, is the master control component. The master control component is a multi-pole, multi-throw switch that controls the function of components 501 and 502; the computer operator can readily accesses this component from outside the computer system's case. The master control component is configurable. Being configurable means that an appropriate number of poles would be used to synchronously control 501 and 502. Being configurable also means that this component may by constructed of mechanical, electromechanical, and/or electronic sub-components.

These three components, 501, 502, and 503 function only as a single unit; they operate synchronously.

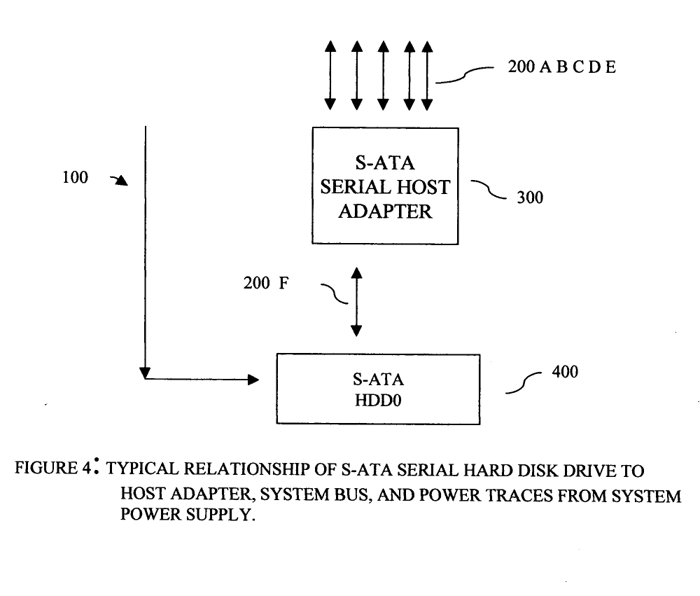

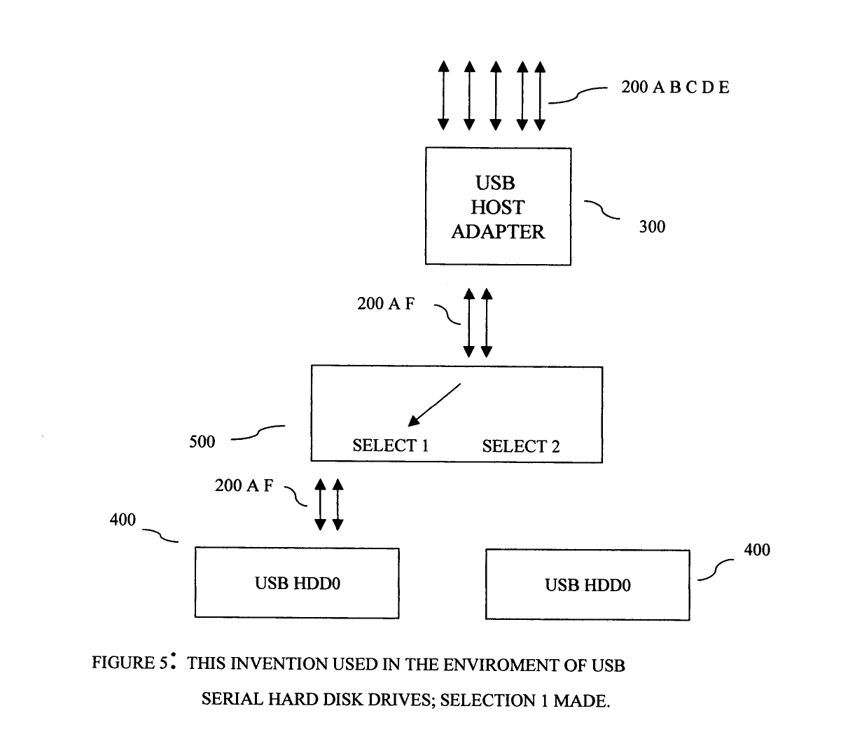

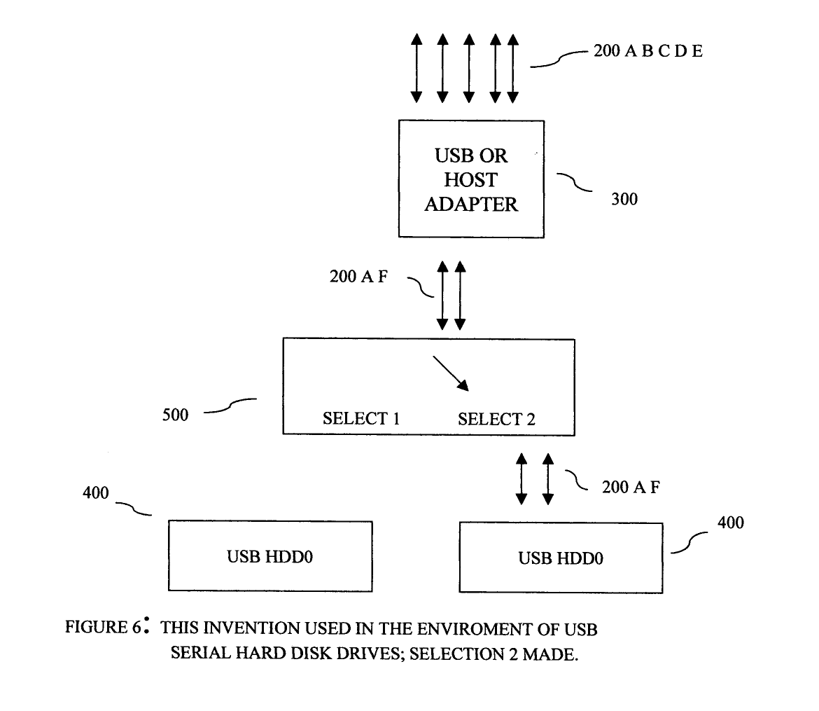

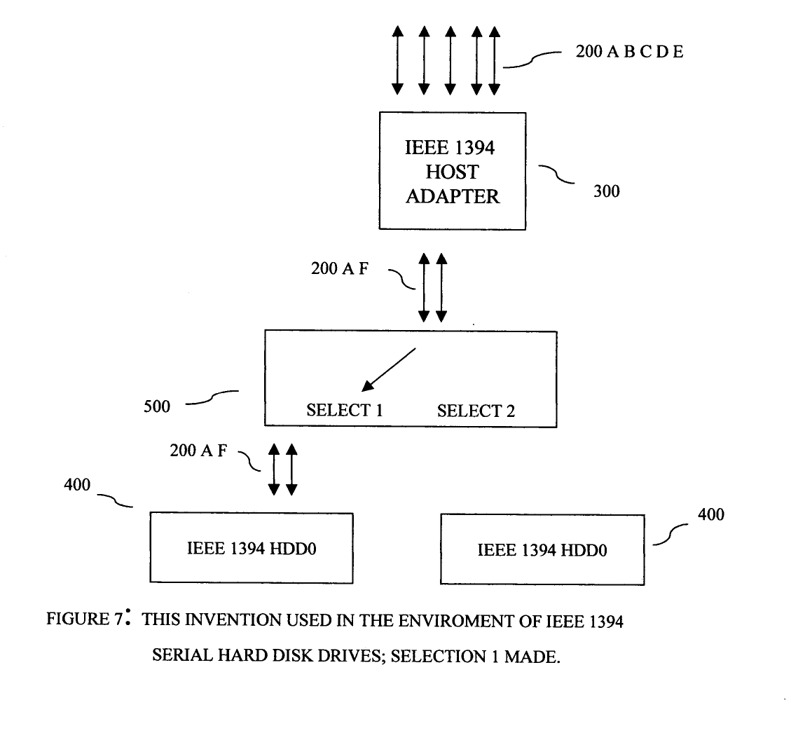

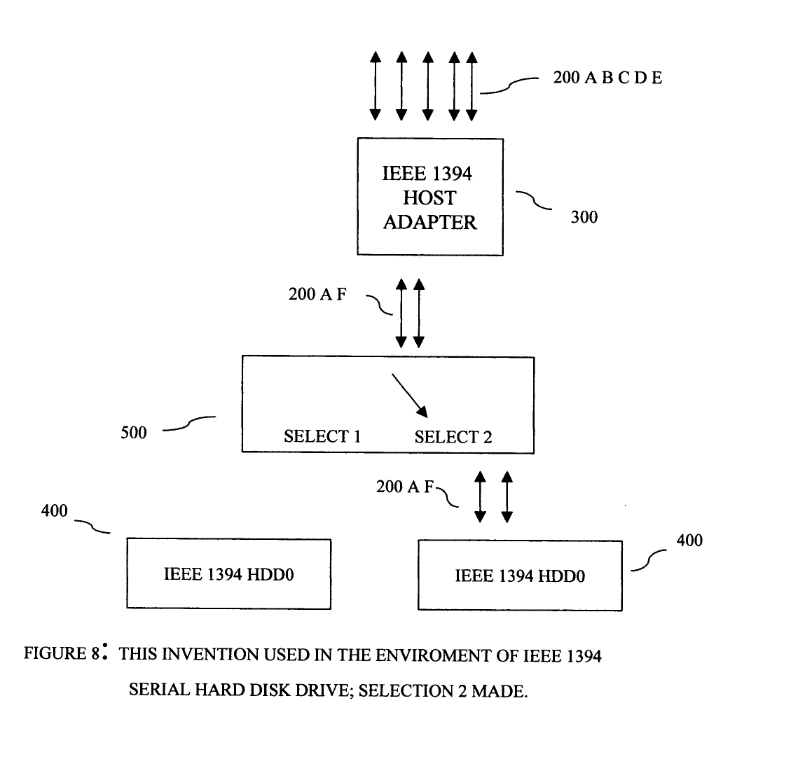

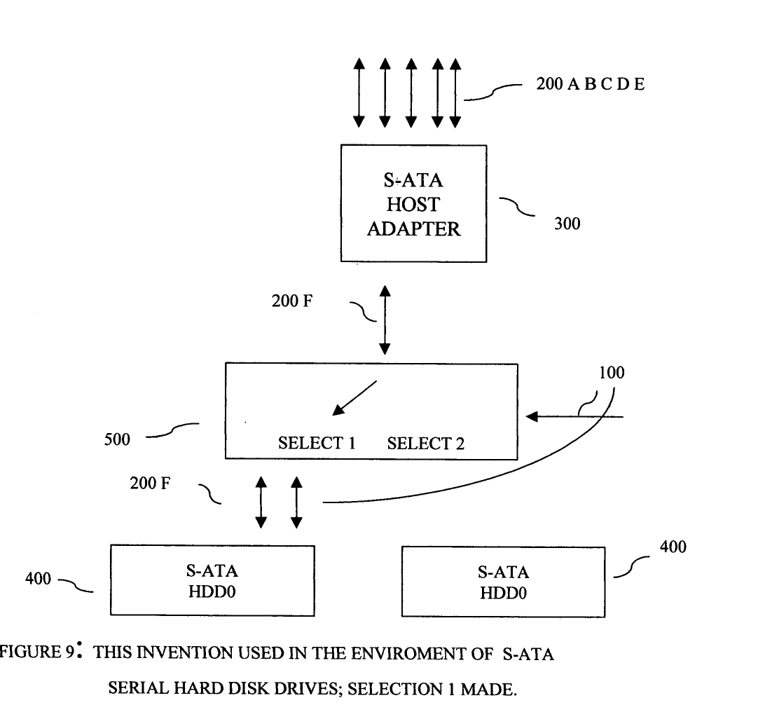

The Serial Hard Disk Drive Selector, 500, is depicted in various serial protocol environments in FIGS. 4, 5, 6, 7, 8, and 9. In FIGS. 4 and 5, it is depicted in the Uniform Serial Bus environment. In FIGS. 6 and 7, it is depicted in the IEEE1394 environment. In FIGS. 8 and 9, it is depicted in the Serial ATA environment. In FIGS. 4, 6, and 8, the Serial Hard Disk Drive Selector is shown selecting the left hand serial hard disk drive and not-selecting the right hand serial hard disk drive. In FIGS. 5, 7, and 9, the Serial Hard Disk Drive Selector is shown selecting the right hand serial hard disk drives and not-selecting the left hand serial hard disk drives. These FIGS. 4 to and including 9, depict only two serial hard disk drives for graphic simplicity; the Serial Hard Disk Drive can be configured for one, two, three, four, etc., number of serial hard disk drives.

Any hard disk drive whose position in a computer system is controlled by the Serial Hard Disk Drive Selector and that is a not-selected serial hard disk drive during any operating session has it contents completely protected from both reading and writing operations.

The master control components function is controlled by a keyed switch that uses a removable key.

1. A Serial Hard Disk Drive Selector mounted permanently within a single computer system that couples one of a plurality of serial hard disk drives connected to the computer system through the Serial Hard Disk Drive Selector to the serial hard disk drive host adapter and a computer system power source so that the coupled serial hard disk drive occupies a single, logical serial hard disk drive position and uncouples the other serial hard disk drives of this plurality of serial hard disk drives during a single computer system use session, this coupling and uncoupling occurring prior to booting the computer system and comprising; three component parts, a master control component, a power control component, and an address/command and control/data control. component; wherein the components are multi-pole, multi-throw switching elements with predetermined numbers of poles to switch all circuits in each peripheral bus segment of the computer system they are used in and with predetermined number of throws to control the selection of the desired serial hard disk drive attached to the Serial Hard Disk Drive Selector; the three components are configurable;
a) the master control component is accessible from the outside of the computer system's case by the user and synchronously controls the operation of the power control and the address/command and control/data control components to close their circuits to the user selected serial hard disk drive to place the serial hard disk drive in an operational mode and open their circuits to any not-selected serial hard disk drives from the serial hard disk drives connected to the Serial Hard Disk Drive Selector to place the not-selected serial hard disk drives in non-operational mode; wherein the master control component is operated by a switch that has a removable key as a security feature;
b) the power control component is coupled between the computer system's electrical supply bus and the power supply terminal of each of the plurality of the serial hard disk drives; and closes the circuit from the computer system's power supply to the user selected serial hard disk drive and opens the circuits to any not-selected serial hard disk drives from the plurality of the serial hard disk drives connected to the Serial Hard Disk Drive Selector;
c) the address/command/data control component is coupled between the computer system's serial hard disk drive host adapter and the plurality of the serial hard disk drives and closes the address/command/data carrying circuits between the host adapter and the user selected serial hard disk drive and opens the address/command/data carrying circuits between the host adapter to the not-selected serial hard disk drives connected to the Serial Hard Disk Drive Selector.
